(19) United States
(12) Patent Application Publication
(10) Pub. No.: US 2025/0135910 A1
(43) Pub. Date: May 1, 2025

(54) TECHNIQUES FOR FULL USER CONTROL OF ELECTRIFIED VEHICLE RANGE EXTENSION

(71) Applicant: FCA US LC, Auburn Hills, MI (US)

(72) Inventors: Kamal Bouyoucef, Rochester Hills, MI (US); Ali Sina Shonei, Birmingham, MI (US); Hanane Hemi, Fes (MO); Feisel Weslati, Troy, MI (US)

(21) Appl. No.: 18/499,668

(22) Filed: Nov. 1, 2023

(51) Int. Cl. B60L 15/20; G06F 3/04847

(52) U.S. Cl. CPC B60L 15/2045; G06F 3/04847; B60L 2250/12; B60L 2250/16; B60L 2260/54

(57) ABSTRACT

User-customizable range extension techniques for battery electric vehicles (BEVs) include receiving, by a controller and from a user interface, a first user input from a user indicating a range extension level for operation of the BEV, the range extension level indicating a reduced operation of the BEV relative to a normal operation of the BEV to increase the range of the BEV, receiving, by the controller and from the user interface, a second user input from the user indicating an allocation of the range extension level between a plurality of different systems of the BEV, and controlling, by the controller, the BEV including its plurality of different systems based on the range extension level and the indicated allocation thereof to increase a range of the BEV as specified by the user.

### FIELD

The present application generally relates to electrified vehicles (EVs) and, more particularly, to techniques for full user control of range extension in battery electric vehicles (BEVs).

### BACKGROUND

Range anxiety is one of the major obstacles to the commercialization of electrified vehicles and, more particularly, battery electric vehicles (BEVs). This range anxiety is due to BEVs only having one or more electric motors and a high voltage energy storage (e.g., battery) system for propulsion and not having a conventional fuel-powered internal combustion engine. Conventional range extension strategies include a reduced performance or “ECO Mode.” ECO Mode differs from normal operation of the BEV in that it utilizes predetermined control setpoints and power limitations for vehicle systems such as the propulsion system and a cabin thermal conditioning system. These predetermined control setpoints remain constant regardless of actual variations during the vehicle trip and are typically perceived by the user as poor vehicle acceleration/speed and poor cabin thermal comfort. Accordingly, while such conventional BEV range extension systems and methods do work for their intended purpose, there exists an opportunity for improvement in the relevant art.

### SUMMARY

According to one example aspect of the invention, a user-customizable range extension system for a battery electric vehicle (BEV) is presented. In one exemplary implementation, the user-customizable range extension system comprises a user interface configured to display information and to receive user input from the user to control operation of the BEV and a range of the BEV and a controller configured to receive, by the user via the user interface, a first user input indicating a range extension level for operation of the BEV, the range extension level indicating a reduced operation of the BEV relative to a normal operation of the BEV to increase the range of the BEV, receive, by the user via the user interface, a second user input indicating an allocation of the range extension level between a plurality of different systems of the BEV, and control the BEV including its plurality of different systems based on the range extension level and the indicated allocation thereof to increase a range of the BEV as specified by the user.

In some implementations, the range extension level is between 0%, which corresponds to zero range extension, and 100%, which corresponds to a maximum amount of range extension. In some implementations, the plurality of different systems of the BEV include a propulsion system, a thermal management system, and an auxiliary power system. In some implementations, the allocation of the range extension level between the plurality of different systems of the BEV includes three percentages that sum to the range extension level. In some implementations, the user interface is further configured to display a single primary slider input for receiving the first user input.

In some implementations, the user interface is further configured to display a single secondary dual-range slider input for receiving the second user input. In some implementations, the user interface is further configured to receive the first and second inputs from the user prior to a start of a current trip of the BEV. In some implementations, the user interface is further configured to receive the first and second inputs from the user as adjustments during the current trip of the BEV. In some implementations, neither the first nor second user inputs specifies a selectable economical mode indicating a predetermined reduced operation of the BEV to extend its range.

According to another example aspect of the invention, a user-customizable range extension method for a BEV is presented. In one exemplary, the user-customizable range extension method comprises receiving, by a controller and from a user interface, a first user input from a user indicating a range extension level for operation of the BEV, the range extension level indicating a reduced operation of the BEV relative to a normal operation of the BEV to increase the range of the BEV, receiving, by the controller and from the user interface, a second user input from the user indicating an allocation of the range extension level between a plurality of different systems of the BEV, and controlling, by the controller, the BEV including its plurality of different systems based on the range extension level and the indicated allocation thereof to increase a range of the BEV as specified by the user.

In some implementations, the range extension level is between 0%, which corresponds to zero range extension, and 100%, which corresponds to a maximum amount of range extension. In some implementations, the plurality of different systems of the BEV include a propulsion system, a thermal management system, and an auxiliary power system. In some implementations, the allocation of the range extension level between the plurality of different systems of the BEV includes three percentages that sum to the range extension level. In some implementations, the method further comprises displaying, by the user interface, a single primary slider input for receiving the first user input.

In some implementations, the method further comprises displaying, by the user interface, a single secondary dual-range slider input for receiving the second user input. In some implementations, the method further comprises receiving, by the controller and from the user interface, the first and second inputs from the user prior to a start of a current trip of the BEV. In some implementations, the method further comprises receiving, by the controller and from the user interface, the first and second inputs from the user as adjustments during the current trip of the BEV. In some implementations, neither the first nor second user inputs specifies a selectable economical mode indicating a predetermined reduced operation of the BEV to extend its range.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a battery electric vehicle (BEV) having an example user-customizable range extension system according to the principles of the present application;

FIG. 2 is a diagram of an example user interface for controlling the user-customizable range extension system of a BEV according to the principles of the present application; and

FIG. 3 is a flow diagram of an example user-customizable range extension method for a BEV according to the principles of the present application.

### DESCRIPTION

As previously discussed, range anxiety is a major obstacle to the commercialization of electrified vehicles and, more particularly, battery electric vehicles (BEVs). This is due to a variety of factors, such as the limited range of BEVs, the scarcity of roadside charging stations, and the relatively long duration of recharging compared to conventional internal combustion engine (ICE) refueling. Conventional range extension strategies include a reduced-performance or “ECO Mode” that can be selectively activated/deactivated by a user. ECO Mode differs from normal operation of a battery electric vehicle (BEV) in that it utilizes predetermined control setpoints and power limitations for vehicle systems such as the propulsion system and a cabin thermal conditioning system. These predetermined control setpoints remain constant regardless of actual variations during the vehicle trip and are typically perceived by the user as poor vehicle acceleration/speed and poor cabin thermal comfort.

As a result, this application is directed to improved fully-customizable range extension of a BEV by a user. This “extension factor” could also be referred to as a “YAZ” range factor, where YAZ is the symbol ( [symbol] ) that means “freedom” in Berber/Amazigh languages. The user (e.g., the driver) is able to fully customize the amount of range extension (from 0% to 100%) as well as the split of this amount of range extension between the vehicle's propulsion systems, thermal management systems, and auxiliary power management systems. The driver could, for example, initially specify some levels for each of these via a driver interface (e.g., touch display) prior to a trip. During the trip, the driver could also adjust these levels based on their perceived feedback. The primary benefit of these techniques is an improved user experience for BEVs.

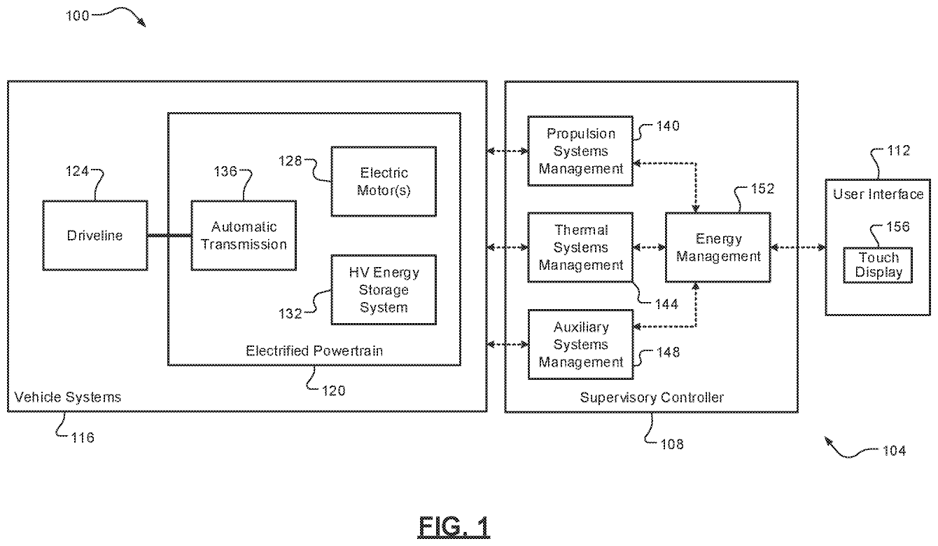

Referring now to FIG. 1, a functional block diagram of a BEV 100 having an example user-customizable range extension system 104 according to the principles of the present application is presented. The term “BEV” as used herein refers to electrified vehicles (EVs) limited to all-electric operation and without a backup/secondary traditional fuel source (gasoline, diesel, etc.). The range extension system 104 generally comprises a supervisory controller 108 of the BEV 100 and a user interface 112 of the BEV 100. The BEV 100 further includes vehicle systems 116 comprising an electrified powertrain 120 configured to generate and transfer drive torque to a driveline 124. The electrified powertrain 120 includes one or more electric motors 128 powered via a high voltage energy system 132 (e.g., a high voltage battery system) to generate torque and an automatic transmission 136 configured to transfer the torque to the driveline 124. The vehicle systems 116 further comprise one or more thermal systems (not specifically shown) and one or more auxiliary systems (not specifically shown).

The thermal systems include, for example, systems configured to thermally manage or condition specific environments of the BEV 100, such as a cabin of the BEV 100, the high voltage energy system 132, the automatic transmission 136, other power electronics, and the like. The auxiliary systems include, for example, a plurality of auxiliary loads (e.g., low voltage auxiliary loads, such as 12 Volt (V) auxiliary loads including an infotainment system, pumps, fans, lamps, and the like). One primary control function of the supervisory controller 108 is to control the propulsion systems (e.g., electrified powertrain 120) to satisfy a torque request, which could be provided by a user (e.g., a driver) of the BEV 100 via the user interface 112 (e.g., an accelerator pedal). The supervisory controller 108 is also configured to perform at least a portion of the user-customizable range extension techniques of the present application via a propulsion systems management 140, a thermal systems management 144, an auxiliary systems management 148, and an energy management 152. This includes receiving, via user (e.g., driver) interaction with the user interface 112 (e.g., a touch display 156), first and second user inputs indicating a range extension level and an allocation of the range extension level amongst a plurality of different vehicle systems, respectively. These vehicle systems include propulsion systems (e.g., the electrified powertrain 120), thermal systems, and auxiliary systems.

The thermal systems could also be include, for example, (a) a heating/ventilating/air conditioning (HVAC) system that is primarily configured to control temperature(s) of an in-cabin environment of the BEV 100, (b) high voltage energy system (e.g., high voltage battery pack) thermal conditioning that is primarily designed to heat up, cool down, and thermal balance the high voltage battery cells, and/or (c) other component thermal conditioning such as the transmission 136, propulsion electric motors, power electronics components. It will be appreciated that the thermal systems could include other temperature conditioning systems (glass defrosting, component heating/cooling, etc.). The auxiliary systems, as previously mentioned, include a plurality of auxiliary loads of the BEV 100, such as 12V auxiliary loads. These auxiliary loads are separate from the thermal systems, which could also include its own set of low/12V loads. Non-limiting examples of the auxiliary systems include dash/instrument clusters, an infotainment unit, a touch display (e.g., touch display 156 of user interface 112), pumps, and fans. It will be appreciated that the electrical load of each of these systems on the electrical system of the BEV 100 could widely vary depending on the user-specified settings or preferences.

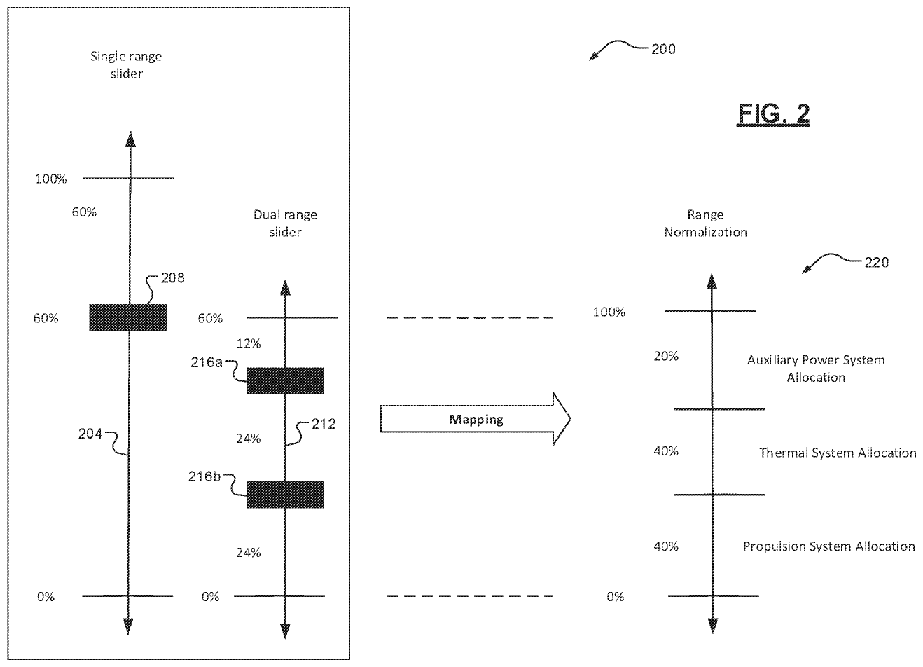

Referring now to FIG. 2, a diagram of an example user interface 200 for controlling a user-customizable range extension system of a BEV (e.g., system 104 of BEV 100) according to the principles of the present application is illustrated. The present application introduces an innovative approach that proactively extends the BEV range while ensuring decent vehicle drive mode and comfort standards. This new strategy will give a user (e.g., the driver) full control and freedom to manage his/her vehicle range. Specifically, the driver can freely manage his/her vehicle range extension before the current trip departure by setting, on the user interface 112 (e.g., the touch display 156), the range extension level of “YAZ range factor” (also referred to as “range factor”) [symbol] . Hence, using this range factor [symbol] , the driver can control the tradeoff between the range extension and the level of vehicle drive mode and comfort standards. A single primary slider input 204 is used to provide a first user input 208 of a specific value for the range factor [symbol] .

The range factor [symbol] can have a value between 0% and 100%, inclusive, where 0% corresponds to a non-extended or normal vehicle range Rᵤ and 100% corresponds to the maximum extended range R_{EM} (similar to the conventional “ECO Mode”). Any intermediary value of [symbol] corresponds to the optimized range Rₒ that is calculated using the following formula: Rₒ=Rᵤ+ [symbol] (R_{EM}−Rᵤ). As shown, the first user input indicates a value of 60% for the range factor [symbol] , which means that 60% of a maximum amount of range extension is desired by the user/driver. In addition to the range factor [symbol] , the driver can also freely configure, such as before the current vehicle trip, the percentage of power to be allocated to each one of the vehicle power systems, namely, the propulsion systems, the thermal systems, and the systems. Each of these systems is controlled by a separate control block of the supervisory controller 108—i.e., the propulsion systems management 140, the thermal systems management 144, and the auxiliary systems management 148.

The driver can freely manage his/her desired power allocation by setting, on the user interface 112 (e.g., the touch display 156), power distribution or allocation factors, ∝_{pr,E}, β_{th,E}, and γ_{aux,E} corresponding to the propulsion systems, the thermal systems, and the auxiliary systems, respectively. In some implementations, these power distribution or allocation factors ∝_{pr,E} β_{th,E}, and γ_{aux,E} could be normalized as shown so that their sum θ_{tot,E} is equal to 100% (40%, 40%, and 20%, respectively). If not normalized, their sum will equal the value of the range factor [symbol] (e.g., 24%, 24%, and 12%). In one exemplary implementation, a dual-range slider could be utilized having one axis 212 and two slidable buttons 216a, 216b for user input to specify the three corresponding ranges for the power distribution or allocation factors ∝_{pr,E}, β_{th,E}, and γ_{aux,E}. Through a normalization mapping, this could then be converted to normalized percentages (i.e., relative to 100%). In another exemplary implementation, three separate slider inputs with separate axes and single slidable buttons could be utilized and could be interconnected such that when one of the selected buttons moves, one or more of the other selections moves (e.g., such that the total always equals the range factor [symbol] or the normalized 100%).

The above objectives could be achieved by predicting the optimized energy consumption trajectories E_{pr,o}^{t}(t), E_{th,o}^{t}(t) and E_{aux,o}^{t}(t) to be tracked by the different vehicle power users, namely, the propulsion systems, the thermal systems, and the auxiliary systems, respectively. Based upon the trip conditions that are known prior to the departure, the optimized energy consumption trajectories will be generated before the current trip departure and could also be updated during the current trip, by adding constraints to the unconstrained energy consumption trajectories E_{pr,u}^{t}(t), E_{th,u}^{t}(t) and E_{aux,u}^{t}(t) corresponding to the same aforementioned vehicle power users. The unconstrained energy consumption trajectories E_{pr,u}^{t}(t), E_{th,u}^{t}(t) and E_{aux,u}^{t}(t) could also be generated before the current trip departure and updated during the current trip. The constraints that are added to the latter unconstrained energy consumption trajectories are optimally spread across the different pre-defined trip segments.

The unconstrained total energy consumption trajectory E_{tot,u}^{t}(t) is the summation of the unconstrained energy consumption trajectories E_{pr,u}^{t}(t), E_{th,u}^{t}(t) and E_{aux,u}^{t}(t) corresponding to the three aforementioned vehicle power users. The unconstrained total energy consumption trajectory E_{tot,u}^{t}(t) corresponds to the non-extended vehicle range Ry. The fully constrained total energy consumption trajectory E_{tot,EM}^{t}(t) is the summation of the fully-constrained trajectories E_{pr,EM}^{t}(t), E_{th,EM}^{t}(t) and E_{aux,EM}^{t}(t) corresponding to the three aforementioned vehicle power users. The fully constrained total energy consumption trajectory E_{tot,EM}^{t}(t) corresponds to the fully extended vehicle range R_{EM}. The optimized total energy consumption trajectory E_{tot,o}^{t}(t) is the summation of the optimized energy consumption trajectories E_{pr,o}^{t}(t), E_{th,o}^{t}(t) and E_{aux,o}^{t}(t) corresponding to the three aforementioned vehicle power users.

The optimized total energy consumption trajectory E_{tot,o}^{t}(t) corresponds to the optimized vehicle range Rₒ through the range factor [symbol] . A range factor [symbol] equal to 0% corresponds to the non-extended vehicle range Rᵤ and the unconstrained total energy consumption trajectory E_{tot,u}^{t}(t), whereas a range factor [symbol] equal to 100% corresponds to the maximum extended range R_{EM} and the fully constrained total energy consumption trajectory E_{tot,EM}^{t}(t). Moreover, the total optimized trajectory E_{tot,o}^{t}(t) that results after manipulating the range factor [symbol] is equal to the unconstrained energy consumption E_{tot,u}^{t}(t) multiplied by θ_{tot, E}. A total energy/power (equal to 100%) θ_{tot,E} is the summation of the normalized power distribution factors ∝_{pr,E}, β_{th,E}, and γ_{sux,E} corresponding to the three vehicle power users.

Additionally, savings on the vehicle state of charge (SOC) will be achieved as the depletion of the optimized vehicle SOC trajectory SOCₒₚₜ^{t}(t) will be slower than the depletion of the unconstrained vehicle SOC trajectory SOCᵤ^{t}(t). The propulsion systems management 140 of the supervisory controller 108 will proactively optimize its propulsion management algorithm so that its energy consumption will be upper bounded by the optimized energy consumption trajectory E_{pr,o}^{t}(t). The thermal systems management 144 of the supervisory controller 108 will proactively optimize its thermal management algorithm so that its energy consumption will be upper bounded by the optimized energy consumption trajectory E_{th,o}^{t}(t). Lastly, the auxiliary systems management 148 of the supervisory controller 108, will proactively optimize its auxiliary power management algorithm so that its energy consumption will be upper bounded by the optimized energy consumption trajectory E_{aux,o}^{t}(t).

Starting with the optimized energy consumption trajectories E_{pr,o}^{t}(t), E_{th,o}^{t}(t) and E_{aux,o}^{t}(t) determined prior to the current trip departure, real-time information about the current trip and the operating state of the BEV 100 are used to update the said trajectories as the trip progresses. Sufficient flexibilities can be incorporated in updating the trajectories online (i.e., during operation of the BEV 100) so that occasional deviations from the optimized trajectories are compensated in the subsequent segments of the current trip to ensure the desirable optimized range is still achieved. Additionally, and while the BEV range is extended based upon the optimization of the total energy consumption, the BEV operation will achieve maximum cost savings while also providing the user/driver will fully-customizable (free) control of the BEV range and its power distribution/allocation between various power systems.

Three major differences can be distinguished between the proposed strategy of the present application and the conventional or existing solutions. By optimizing the power consumption trajectories for the specific conditions of the trip, the proposed strategy minimizes the impact on the performance of the affected systems and ensures a desirable user experience. Existing range extension strategies over-constrain all energy consumers irrespective of the conditions of the trip and unnecessarily degrade acceleration, speed, and thermal comfort at the same time. By updating the power consumption trajectories of the vehicle systems in real-time, the proposed strategy actively balances the priority of different vehicle systems based on the real time conditions of the trip and the operating state of the vehicle.

This ensures the best overall operation of the BEV the least impact on the users, while achieving the desirable range improvement. In existing strategies, the power supply limitations remain constant once activated, therefore all affected systems are constantly degraded. Possibility for further SOC savings through optimization of individual systems control (propulsion, thermal, accessory) using their provided new maximum/upper bound values. In other words, while new upper bound values are determined and provided for each of these systems, the systems could end up using less than the expected or anticipated amount of energy and thus could actually save even more SOC/range. Either way, the user/driver will be able to freely control the BEV's energy expenditure and range such that they are comfortable with the range as well as the performance/comfort settings. This improved the overall user experience and ideally overcomes one of the major obstacles to the commercialization of BEVs.

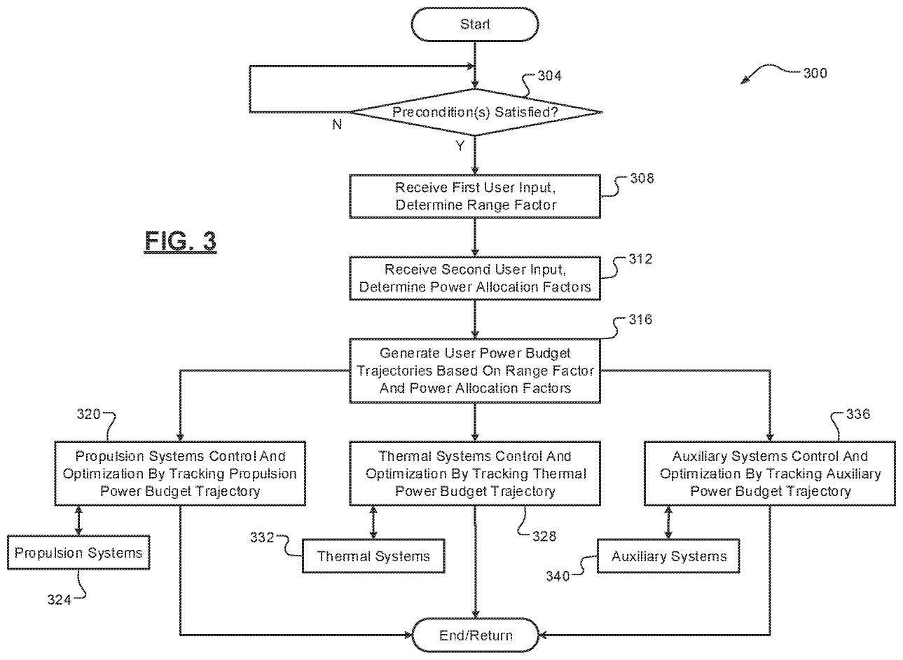

Referring now to FIG. 3, a flow diagram of an example user-customizable range extension method 300 for a BEV according to the principles of the present application is illustrated. While the BEV 100 and the components of FIGS. 1-2 are specifically referenced for illustrative/descriptive purposes, it will be appreciated that the method 300 could be applicable to any suitably configured BEV. At 304, the supervisory controller 108 determines whether an optional set of one or more preconditions are satisfied. This could include, for example only, the BEV 100 being started or powered-up and there being no malfunctions or faults present that would otherwise inhibit the operation of the BEV 100 and the method 300. When false, the method 300 ends or returns to 304. When true, the method 300 continues to 308 where the user/driver provides a first user input (e.g., via the user interface 112 or, more specifically, the touch display 156) indicating the range factor or desired range extension level.

At 312, the supervisory controller 108 receives a second user input (e.g., via the user interface 112 or, more specifically, the touch display 148) indicating a desired distribution or allocation of the range factor (i.e., the power allocation factors) or extension level amongst a plurality of vehicle power systems (e.g., the propulsion systems, the thermal systems, and the auxiliary systems). At 316, the supervisory controller 108 (i.e., the energy management 152) generates user power budget trajectories based on the range factor and the power allocation factors. The method 300 then splits into three simultaneous or parallel paths. At 320, the supervisory controller 108 controls the propulsion systems, via the propulsion systems management 140, by tracking the propulsion power budget trajectory. This includes feedback-based control of the propulsion systems (e.g., the electrified powertrain 120), shown here as 324. At 328 and 336, the supervisory controller 108 controls the thermal systems and the auxiliary systems, respectively, via the thermal systems management 144 and auxiliary systems management 148, by tracking the thermal/auxiliary power budget trajectories, respectively. This includes feedback-based control of the thermal and auxiliary systems, shown here as 332 and 340, respectively. This process could continue, for example, during the operation of the BEV 100 until a subsequent key-off or power-down event. This allows the user/driver to adjust the settings, such as the distribution/allocation, based on their own personal feedback, which could allow them to further improve or extend the range of the BEV 100. The method 300 then ends or returns to 304 for another cycle.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A user-customizable range extension system for a battery electric vehicle (BEV), the user-customizable range extension system comprising:
a user interface configured to display information and to receive user input from the user to control operation of the BEV and a range of the BEV; and
a controller configured to:
receive, by the user via the user interface, a first user input indicating a range extension level for operation of the BEV, the range extension level indicating a reduced operation of the BEV relative to a normal operation of the BEV to increase the range of the BEV;
receive, by the user via the user interface, a second user input indicating an allocation of the range extension level between a plurality of different systems of the BEV; and
control the BEV including its plurality of different systems based on the range extension level and the indicated allocation thereof to increase a range of the BEV as specified by the user.

2. The user-customizable range extension system of claim 1, wherein the range extension level is between 0%, which corresponds to zero range extension, and 100%, which corresponds to a maximum amount of range extension.

3. The user-customizable range extension system of claim 2, wherein the plurality of different systems of the BEV include a propulsion system, a thermal management system, and an auxiliary power system.

4. The user-customizable range extension system of claim 3, wherein the allocation of the range extension level between the plurality of different systems of the BEV includes three percentages that sum to the range extension level.

5. The user-customizable range extension system of claim 4, wherein the user interface is further configured to display a single primary slider input for receiving the first user input.

6. The user-customizable range extension system of claim 5, wherein the user interface is further configured to display a single secondary dual-range slider input for receiving the second user input.

7. The user-customizable range extension system of claim 1, wherein the user interface is further configured to receive the first and second inputs from the user prior to a start of a current trip of the BEV.

8. The user-customizable range extension system of claim 7, wherein the user interface is further configured to receive the first and second inputs from the user as adjustments during the current trip of the BEV.

9. The user-customizable range extension system of claim 1, wherein neither the first nor second user inputs specifies a selectable economical mode indicating a predetermined reduced operation of the BEV to extend its range.

10. A user-customizable range extension method for a battery electric vehicle (BEV), the user-customizable range extension method comprising:
receiving, by a controller and from a user interface, a first user input from a user indicating a range extension level for operation of the BEV, the range extension level indicating a reduced operation of the BEV relative to a normal operation of the BEV to increase the range of the BEV;
receiving, by the controller and from the user interface, a second user input from the user indicating an allocation of the range extension level between a plurality of different systems of the BEV; and
controlling, by the controller, the BEV including its plurality of different systems based on the range extension level and the indicated allocation thereof to increase a range of the BEV as specified by the user.

11. The user-customizable range extension method of claim 10, wherein the range extension level is between 0%, which corresponds to zero range extension, and 100%, which corresponds to a maximum amount of range extension.

12. The user-customizable range extension method of claim 11, wherein the plurality of different systems of the BEV include a propulsion system, a thermal management system, and an auxiliary power system.

13. The user-customizable range extension method of claim 12, wherein the allocation of the range extension level between the plurality of different systems of the BEV includes three percentages that sum to the range extension level.

14. The user-customizable range extension method of claim 13, further comprising displaying, by the user interface, a single primary slider input for receiving the first user input.

15. The user-customizable range extension method of claim 14, further comprising displaying, by the user interface, a single secondary dual-range slider input for receiving the second user input.

16. The user-customizable range extension method of claim 10, further comprising receiving, by the controller and from the user interface, the first and second inputs from the user prior to a start of a current trip of the BEV.

17. The user-customizable range extension method of claim 16, further comprising receiving, by the controller and from the user interface, the first and second inputs from the user as adjustments during the current trip of the BEV.

18. The user-customizable range extension method of claim 10, wherein neither the first nor second user inputs specifies a selectable economical mode indicating a predetermined reduced operation of the BEV to extend its range.
